(19) United States
(12) Patent Application Publication
(10) Pub. No.: US 2012/0008769 A1
(43) Pub. Date: Jan. 12, 2012

(54) Method and System For Managing A Distributed Identity

(76) Inventors: Kurt Raffiki Collins, San Francisco, CA (US); Aaron Knoll, Holtsville, NY (US); Jennifer Paul, Yaphank, NY (US)

(21) Appl. No.: 13/181,256

(22) Filed: Jul. 12, 2011

Related U.S. Application Data
(60) Provisional application No. 61/363,491, filed on Jul. 12, 2010.

(51) Int. Cl. G06F 21/00; H04L 9/08

(52) U.S. Cl. 380/44; 726/6

(57) ABSTRACT

A method for managing a distributed identity, including retrieving identification data of a user, wherein the identification data includes a username, a password, and metadata; receiving, from a general-use device, a unique physical identifier of the user; combining the unique physical identifier and the identification data to create a unique identity record of the user; encrypting at least a component of the unique identity record; creating a hash of an identifying token of the unique identity record; passing the hash of the identity token of the unique identity record to be parsed into a hierarchy; organizing the unique identity record in a distributed database of a plurality of unique identity records; and storing the unique identity record, containing the encrypted component, in the distributed database of the plurality of unique identity records.

### CROSS-REFERENCE TO RELATED APPLICATIONS

This application claims the benefit of U.S. Provisional Application No. 61/363,491, filed Jul. 12, 2010 which is incorporated in its entirety by this reference.

### TECHNICAL FIELD

This invention relates generally to the digital identification and authentication field, and more specifically to a new and useful method and system for managing a distributed identity in the digital identification and authentication field.

### BACKGROUND

From serial numbers to IP addresses, email address to usernames, cell phone numbers to electronic serial numbers, there are countless ways people and devices identify themselves. However, because of the differing technologies and protocols, they fail to provide a universal method for cataloging and authenticating identity. As the number of connected people and device continues to increase, the identification and authentication of the numerous users and devices will continually be an increasing problem. Thus, there is a need in the digital identification and authentication field to create a new and useful method and system for managing a distributed identity. This invention provides such a new and useful method and system.

### BRIEF DESCRIPTION OF THE FIGURES

FIG. 1 is a schematic representation of a method for overall encryption of a first preferred embodiment of the invention.

FIG. 2 is a schematic representation of a method for authentication of a second preferred embodiment of the invention.

FIGS. 3 and 4 are schematic representations of systems of preferred embodiments of the invention.

FIGS. 5 and 6 are flowchart representations of steps of encryption of preferred embodiments.

FIGS. 7 and 8 are flowchart representations of steps of authentication of preferred embodiments.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Method for Managing a Distributed Identity

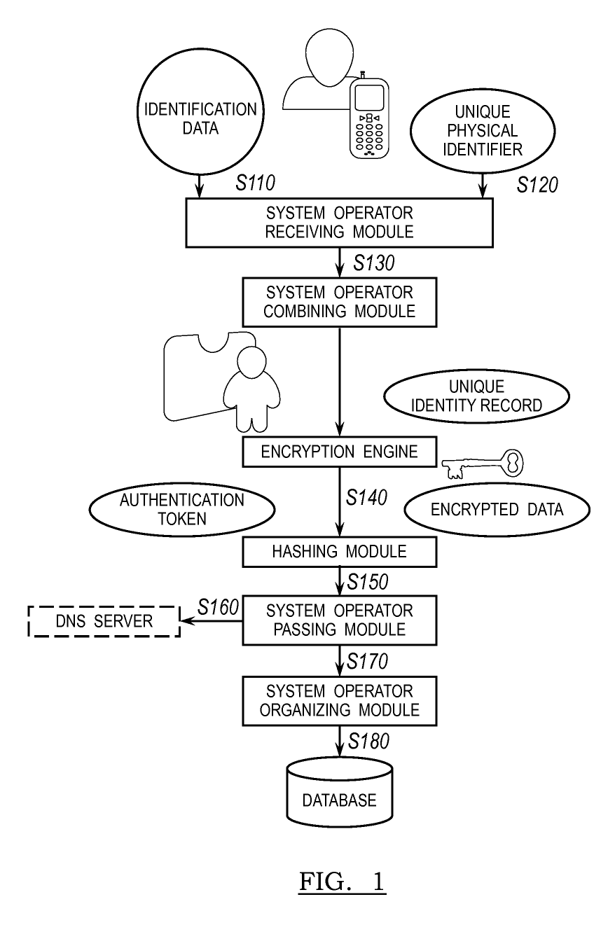

As shown in FIG. 1, a method for managing a distributed identify of a preferred embodiment includes retrieving identification data of a user, wherein the identification data includes a username, a password, and metadata S110; receiving, from a general-use device, a unique physical identifier of the user S120; combining the unique physical identifier and the identification data to create a unique identity record of the user S130; encrypting at least a component of the unique identity record S140; creating a hash of an identifying token of the unique identity record S150; passing the hash of the identity token of the unique identity record to be parsed into a hierarchy S160; organizing the unique identity record in a distributed database of a plurality of unique identity records S170; and storing the unique identity record, containing the encrypted component, in the distributed database of the plurality of the unique identity records S180. The method preferably utilizes a combination of domain name system (DNS) storage and public key cryptography (PKI) to provide a stable and massively scalable architecture for storing, managing, and accessing authentication information. The DNS storage is preferably used as a data failover for storing authentication information. A database system may additionally or alternatively be used. The method preferably uses hardware-based tokens as a password or authentication token during the identification and/or authentication process. A system operator preferably manages the central operation of the method in a non-federated system, but the method may alternatively include steps adapted for use in a federated system with at least one secondary party (e.g., a federated partner). A method for a federated system preferably enables secondary parties to maintain private data even from system operators. The method can be extended to applications for authentication in a payment system (e.g., in store or Internet purchases), customization of computer operation (e.g., a universal remote), or for any suitable application that could benefit from identification and/or authentication of users.

The method is preferably run on a server and/or database that is independent of the general-use device. Alternatively, the platform running the method may also include a software module that is run on the general-use device. For example, the platform may involve an application that must be installed on a user's mobile phone in addition to the database and/or server. The method is preferably executed for a variety of users with the same general-use device. For example, an ATM machine running a software module that comprises the present invention's platform can authenticate multiple users.

Step S110, which includes retrieving identification data of a user functions to receive the information that comprises the identity record. The identification data preferably includes a username, a password, and metadata. The identification data may further include an email address, a cell phone number, an IP address, an electronic serial number, a birthday, a mail address, a social security number, a driver's license number, a photograph, a video, an identifying piece of clipart, an answer to a secret question, a financial instrument (e.g., a credit card), an account number, a biometric datum, or any other suitable piece of identifying data. The retrieval of identification data is preferably completed at the time the user signs-up or creates an account either through a service of the system operator, a partner using an application programming interface (API) to interact with the infrastructure of the system operator, or through any suitable means. The identification data may alternatively be collected at any suitable time. Preferably, the identification data is manually entered into fields on the website. Alternatively, the identification data may be automatically retrieved from data that is already stored on a user's computer or mobile device, or through a mobile phone application, software package, or any other suitable means of data entry. While less-than-ideal, the identification data could also be sent via the postal service to the system operator and entered into a system by the system operator.

Step S120, which includes receiving, from a general-use device, a unique physical identifier of the user, functions to authenticate the user. The unique physical identifier serves as an authentication token. A password may additionally or alternatively be used with the authentication token. The authentication token is preferably related to a personal device associated with a single user. The authentication token can preferably be identified through the presence of the device as is described below. The necessary presence of a physical object for the authentication token preferably adds an additional layer of protection to the identification and authentication of the user. The user token and the authentication token are preferably associated with each other. As mentioned above, the authentication token is preferably related to a personal device associated with a single user. A mobile phone is one exemplary personal device due to the single-user nature of the mobile phone. In one embodiment, the unique physical identifier is a mobile device address. The personal device may alternatively be associated with an account, a family, a company, or any suitable entity that may benefit from identification. The personal device is preferably a mobile phone but may alternatively be a personal computer, a tablet computer, personal data assistant (PDA), handheld gaming device, an electronic book reader, and/or any suitable personal computing device. As another alternative, the personal device may be a non-computing device such as a key with an embedded RFID (Radio Frequency Identification) tag or a magnetic strip card. The personal device is preferably required to be on, with, or near the user during the identification/authentication process. The personal device preferably communicates with the general-use device through near-field communication. Since the personal device is associated with an individual user (or entity), the presence of the personal device signifies to a general-use device or any device facilitating the identification/authentication that the associated user is also present. The personal device preferably includes a wireless communication device such as a Wi-Fi Internet component, Bluetooth component, Zigbee component, and/or any suitable wireless communication device. The wireless communication device preferably communicates over the wireless channel using TCP/IP (Transmission Control Protocol/Internet Protocol) and/or NFC (Near Field Communication) technology but any suitable protocol may be used. The personal device may alternatively use line of sight (e.g., infrared communication) or physical connections (such as a wired connection). The wireless communication device preferably has a unique identifier associated with the communication protocol. Preferably, the wireless communication protocol uses a physical address such as a MAC (Media Access Control) address, a UID (user identifier), a Bluetooth ID, or any suitable device identifying code. The physical address preferably functions to identify a device without establishing a transfer of data other than data required to identify devices available for communication. While identifying various devices available for communication (e.g., the Bluetooth pairing process) the physical address preferably becomes available, thus eliminating any need for establishing a data transfer with a device. A device identifying code may alternatively be transferred through the communication channel. The personal device preferably includes any necessary software or hardware to broadcast the presence of the device through the communication device. Or in other words, the personal device is set to a discoverable mode. A user may alternatively activate the broadcast of availability.

In alternative embodiment, the unique physical identifier of the user is a biometric datum. Preferably, the biometric datum is a fingerprint. Alternatively, the biometric datum may be a palm print, iris scan, genetic identification of a skin or hair cell, or any other suitable imprint of a biological component of the user. The general-use device that receives the unique physical identifier of the user may be an ATM machine, a barcode scanner, a laptop computer, a tablet PC, a stationary PC, an RFID scanner, a mobile phone, or any suitable device capable of receiving the unique physical identifier of the user and transmitting data about that user to a remote server and/or database.

Step S130, which includes combining the unique physical identifier and the identification data to create a unique identity record of the user, functions to make the user's identification data uniquely accessible with the unique physical identifier and, ultimately, to enable authentication. The unique physical identifier is preferably combined with the identification data within the same record, such that encryption of the record will also encrypt the unique physical identifier (which is discussed further in the description of Step S140). Alternatively, the unique physical identifier may be assigned an alphanumeric string that is used to address the unique identity record.

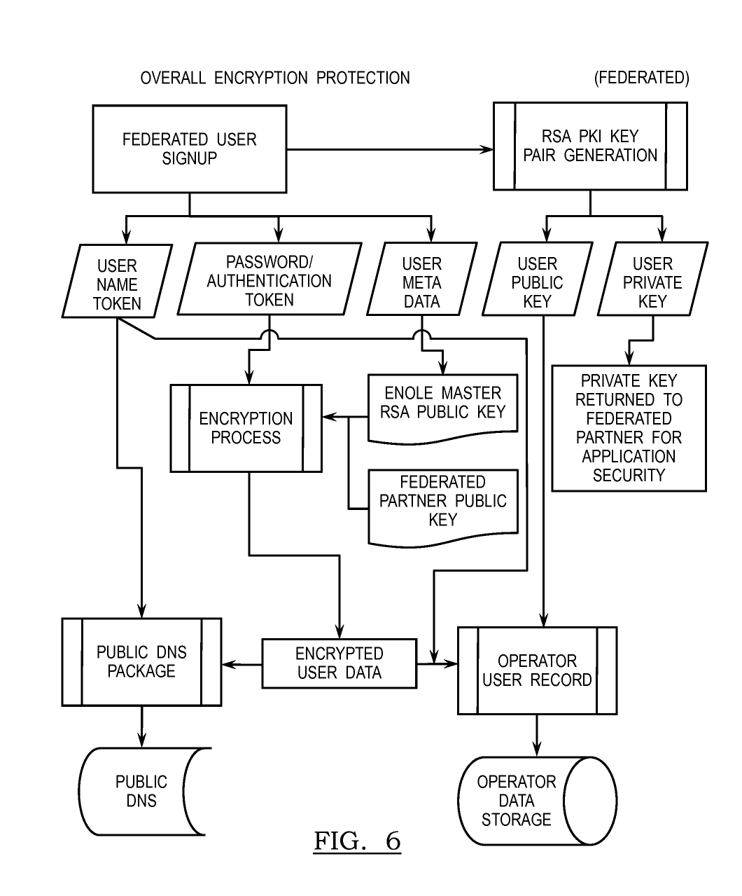

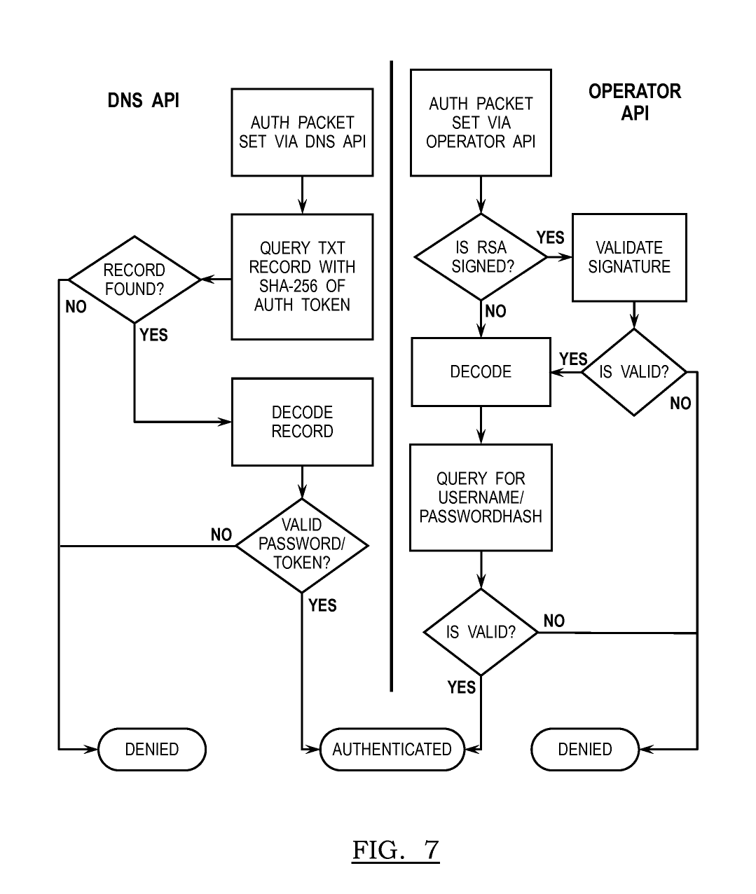

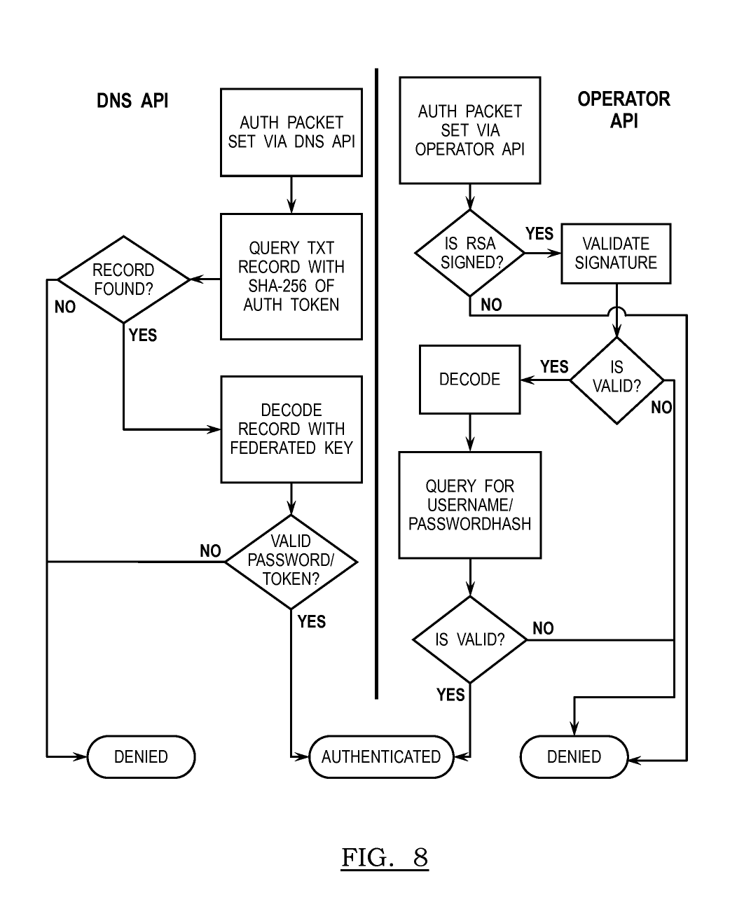

Step S140, which includes encrypting at least a component of the unique identity record, functions to secure the identification information. There are several suitable variations for encrypting the data. In one variation, the component of the unique identity record is encrypted through public key cryptography. The encrypting of the component of the unique identity record preferably includes the generation of an RSA public and private key pair. The private key is preferably accessible to the user. Alternatively, the private key is accessible to a calling API partner. The private key is preferably used to encrypt the algorithm so as to enable the user or calling API partner to provide a digital signature. Alternatively, another type of asymmetric-key cryptography is used. In another variation, the component of the unique identity record is encrypted with a symmetric-key algorithm, in which the same algorithm is utilized for both decryption and encryption. Alternatively, a private key capable of decrypting the component of the unique identity record is generated. As shown in the component of FIG. 6 labeled “federated partner public key,” this private key may be shared with a federated partner, thus enabling a federated encryption process. The federated encryption process adds an additional layer of encryption at the level of the federated partner. In the embodiment involving a federated encryption process, the private key may be further shared with a second federated partner, thus enabling a user's identity to grow as a system of federated partners is built. In this embodiment, the system operator may not have access to the private key that is shared between federated partners, thus enabling the system operator to store and provide access to the records without having access to the contents of the unique identity records of the users. In this embodiment, the federated partners are preferably chosen at the time of user signup. Alternatively, access control rights may be granted and/or taken away after the user signup.

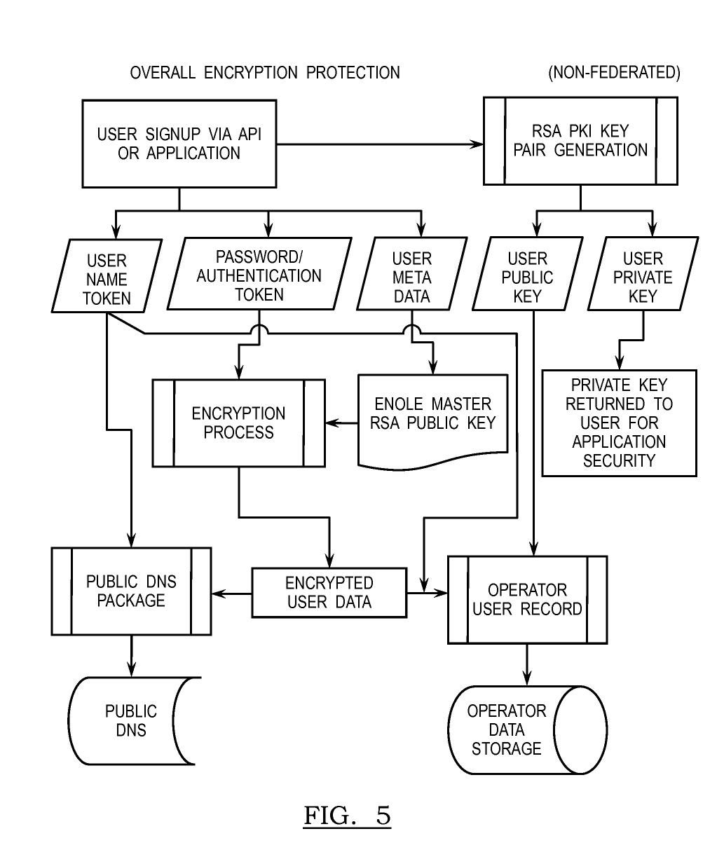

The component of the unique identity record that is encrypted in Step S140 preferably includes the identification data. In an alternative embodiment, the component of the unique identity record that is encrypted may also include the identifying token of the unique identity record. For example, the identifying token of the unique identity record may be the unique physical identifier of the user, in which case this is also encrypted. In one preferred variation, as shown in FIG. 5, the authentication token and metadata are encrypted while the username is at least partially maintained for lookup purposes.

Step S150, which includes creating a hash of an identifying token of the unique identity record, functions to enable secure retrieval of the user's identity record. The identifying token of the unique identity record is preferably the unique physical identifier of the user. Creating a hash of the identifying token of the unique identity record (also referenced as the “authentication token”) helps prevent attackers, hackers, and the like from simulating the identity of the user. Knowledge of the authentication token is thus kept secure in the system. Alternatively, the identifying token may be the username, the password, or any other component of the identification data. The identifying token of the unique identity record in Step S150 is preferably hashed with SHA-256. Alternatively, the identifying token of the unique identity record may be hashed with SHA-224, SHA-384, SHA-512, or any other suitable cryptographic hash function. The identifying token of the unique identity record may also be further encrypted with advanced encryption standard (AES), providing a non-recoverable method of identifying token management.

Step S160, which includes passing the hash of the identifying token of the unique identity record to be parsed into a hierarchy, functions to store authentication information. The parsing of the identifying token is preferably accomplished by the Domain Name System (DNS), which can enable data failover and can decrease lookup time during the authentication process. The unique identity record of the user is preferably passed along with the hash of the identifying token of the unique identity record to DNS. The encrypted data in the record is preferably formatted in a standard XML format, but may alternatively be formatted as JSON or any suitable data representation. The encrypted data is preferably compressed and base-64 encoded, but any suitable encryption may be used. The formatting of the encrypted data preferably occurs on the platform of the present invention. Alternatively, the formatting may occur on a remote server. In one example, the format of the data is preferably: {(hash of the identifying token of the unique identity record)}:{(encoded XML data)}. Storing the data in this format enables it to be easily queried and addressed in DNS. For example, if the system loses access to a database containing a unique identity record, the hash of the identifying token of the unique identity record may be parsed to enable a quick lookup of a duplicate copy of the unique identity record on DNS.

Public DNS is preferably used to enable data failover by providing redundant storage for the unique identity records. Thus, if access to a database of a system operator or federated partner is prevented or compromised, there will be an alternate means for retrieval of a unique identity record. Alternatively, there may be a server belonging to the system operator or federated partner that accomplishes the same tasks as public DNS. Further still, DNS may be used for rerouting of unique identity record addresses. For example, if access to a database containing a unique identity record is compromised, a DNS server may update the address of the unique identity record to be a new address on a new database, at which a duplicate of the unique identity record is copied. In this embodiment, DNS effectively reroutes the address of the unique identity record.

Step S170, which includes organizing the unique identity record in a distributed database of a plurality of unique identity records functions to reduce downtime during the authentication process. Preferably, the organization is accomplished according to the DNS algorithm applied to parsed components of the identifying token of the unique identity record. Alternatively, the unique identity records may be organized with an algorithm that sorts them according to dates on which corresponding accounts were created, an algorithm that sorts them according to geographical locations of users, or any other algorithm that may assist with and speed up the time it takes to look up a unique identity record.

Step S180, which includes storing the unique identity record, containing the encrypted component, in the distributed database of the plurality of unique identity records, functions to maintain a unique identity record in query-able format for future authentication. The distributed database is preferably a secure relational database. The records stored in the distributed database are preferably duplicated on the DNS. Thus, if a component of the distributed database fails, the user identity record can be queried on the DNS. The distributed database is preferably accessible to the system operator. Alternatively, a federated partner or group of federated partners may have private keys necessary to decrypt the unique identity records on the distributed database.

### 2. Method for Authenticating a User's Identity

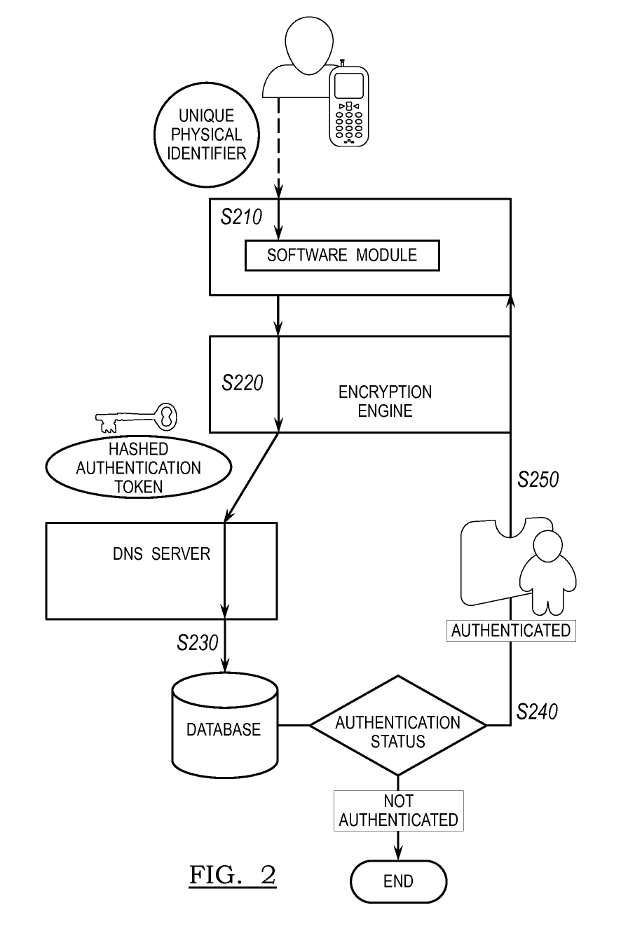

As shown in FIG. 2, a method for authenticating a user's identity in a distributed identity management system of a preferred embodiment includes receiving, from a general-use device, a unique physical identifier of a user S210; creating a hash of the unique physical identifier S220; querying a distributed database of unique identity records, organized according to a hierarchy of names with the hash of the unique physical identifier of the user, for a unique identity record of the user S230; determining, based on a query result, an authentication status S240; and returning, if there is authentication, a component of the contents of the user's identity record S250. The method preferably utilizes a combination of domain name system (DNS) storage and public key cryptography (PKI) to provide a stable and massively scalable architecture for storing, managing, and accessing authentication information. The DNS storage is preferably used as a data failover for storing authentication information. A database system may additionally or alternatively be used. The method preferably uses hardware-based tokens as a password or authentication token during the authentication process. The method is preferably run on a server and/or database that is independent of the general-use device. Alternatively, the platform running the method may also include a software module that is run on the general-use device. For example, the platform may involve an application that must be installed on a user's mobile phone in addition to the database and/or server. The method is preferably executed for a variety of users with the same general-use device. For example, an ATM machine running a software module that comprises the present invention's platform can authenticate multiple users.

Step S210, which includes receiving, from a general-use device, a unique physical identifier of the user, functions to authenticate the user. The unique physical identifier serves as an authentication token. A password may additionally or alternatively be used with the authentication token. The authentication token is preferably related to a personal device associated with a single user. The general-use device is preferably usable to a plurality of users. The authentication token can preferably be identified through the presence of the device as is described below. The necessary presence of a physical object for the authentication token preferably adds an additional layer of protection to the identification and authentication of the user. The user token and the authentication token are preferably associated with each other. As mentioned above, the authentication token is preferably related to a personal device associated with a single user. A mobile phone is one exemplary personal device due to the single-user nature of the mobile phone. In one embodiment, the unique physical identifier is a mobile device address. The personal device may alternatively be associated with an account, a family, a company, or any suitable entity that may benefit from identification. The personal device is preferably a mobile phone but may alternatively be a personal computer, a tablet computer, personal data assistant (PDA), handheld gaming device, an electronic book reader, and/or any suitable personal computing device. As another alternative, the personal device may be a non-computing device such as a key with an embedded RFID (Radio Frequency Identification) tag or a magnetic strip card. The personal device is preferably required to be on, with, or near the user during the identification/authentication process. The personal device preferably communicates with the general-use device through near-field communication. Since the personal device is associated with an individual user (or entity), the presence of the personal device signifies to a general-use device or any device facilitating the identification/authentication that the associated user is also present. The personal device preferably includes a wireless communication device such as a Wi-Fi Internet component, Bluetooth component, Zigbee component, and/or any suitable wireless communication device. The wireless communication device preferably communicates over the wireless channel using TCP/IP (Transmission Control Protocol/Internet Protocol) and/or NFC (Near Field Communication) technology but any suitable protocol may be used. The personal device may alternatively use line of sight (e.g., infrared communication) or physical connections (such as a wired connection). The wireless communication device preferably has a unique identifier associated with the communication protocol. Preferably, the wireless communication protocol uses a physical address such as a MAC (Media Access Control) address, a UID (user identifier), a Bluetooth ID, or any suitable device identifying code. The physical address preferably functions to identify a device without establishing a transfer of data other than data required to identify devices available for communication. While identifying various devices available for communication (e.g., the Bluetooth pairing process) the physical address preferably becomes available, thus eliminating any need for establishing a data transfer with a device. A device identifying code may alternatively be transferred through the communication channel. The personal device preferably includes any necessary software or hardware to broadcast the presence of the device through the communication device. Or in other words, the personal device is set to a discoverable mode. A user may alternatively activate the broadcast of availability.

In alternative embodiment, the unique physical identifier of the user is a biometric datum. Preferably, the biometric datum is a fingerprint. Alternatively, the biometric datum may be a palm print, iris scan, genetic identification of a skin or hair cell, or any other suitable imprint of a biological component of the user. The general-use device that receives the unique physical identifier of the user may be an ATM machine, a barcode scanner, a laptop computer, a tablet PC, a stationary PC, an RFID scanner, a mobile phone, or any suitable device capable of receiving the unique physical identifier of the user and transmitting data about that user to a remote server and/or database.

Step S220, which includes creating a hash of the unique physical identifier of the user, functions to enable secure retrieval of the user's identity record. The identifying token of the unique identity record is preferably the unique physical identifier of the user. Creating a hash of the identifying token of the unique identity record (also referred herein as the “authentication token”) helps prevent attackers, hackers, and the like from simulating the identity of the user. Knowledge of the authentication token is thus kept secure in the system. Alternatively, the identifying token may be the username, the password, or any other component of the identification data. The identifying token of the unique identity record in Step S220 is preferably hashed with SHA-256. The identifying token of the unique identity record may alternatively be hashed with SHA-224, SHA-384, SHA-512, or any other suitable cryptographic hash function. The identifying token of the unique identity record may also be further encrypted with advanced encryption standard (AES), providing a non-recoverable method of identifying token management. The cryptographic hash function used in authentication is preferably the same cryptographic hash function that is used in the initial encryption method. Likewise, if in the encryption method, the identifying token is further encrypted with AES, then it is also further encrypted with AES in the authentication method. The identification token that is used for lookup preferably parallels what is entered into the system in the initial encryption process.

Step S230, which includes querying a distributed database of unique identity records, organized according to a hierarchy of names with the hash of the unique physical identifier of the user, for a unique identity record of the user, functions to send the hash of the unique physical identifier to a database and/or a server. If the data hash is not found, the method may alternatively query DNS storage. The DNS's main purpose is preferably data failover.

Step 240, which includes determining, based on a query result, an authentication status functions to report whether or not the unique identity record is in the system. If the user (1) has previously signed up for an account with the system with a unique physical identifier and (2) carries a device or any other suitable physical object with the same unique physical identifier, then the method may return a positive authentication status, as shown in FIG. 2. If the user has not previously signed up for an account or signed up for an account with a different unique physical identifier, then the method may return a negative authentication status. In the case of a negative authentication status, the method is terminated. In the case of a positive authentication status, the user preferably immediately accesses a component of the contents of his or her unique identity record. Alternatively, the user may be prompted with further questions, password, or any other suitable identifiers to further verify his or her identity.

Step 250, which includes returning, if there is authentication, a component of the contents of the user's unique identity record, functions to transfer requested data to another agent, the transfer of data preferably being the main purpose of authentication in the first place. The components of the user's unique identity record that are returned may be any one of: a username, a password, metadata, an email address, a cell phone number, an IP address, an electronic serial number, a birthday, a mail address, a social security number, a driver's license number, a photograph, a video, an identifying piece of clipart, an answer to a secret question, a financial instrument (e.g., a credit card), an account number, a biometric datum, or any other suitable piece of identifying data. The agent receiving the data may be a payment website, an ATM, or any other recipient requiring identification data.

The methods of the preferred embodiments for managing and authenticating a user's identity in a distributed identity management system may enable a number of innovative techniques that can be applied in stores, venues, and other retail establishments. For example, the methods may enable the provision of concierge-level customer service for any customers, the allowing of customers to easily pre-select and receive on-the-spot discounts on merchandise, in-store customer tracking, mobile payment solutions, and any other retail application that could benefit from quick and easy authentication. The methods may also assist online retailers, otherwise known as “e-tailers.” The methods may offer e-tailers completely different advantages from retailers, including: presence verification on each transaction enabled by the platform, which is a key method in reducing fraudulent transactions; a federation of online and offline merchants with access to identify all users opted into the federation; capability to tie true-to-life identity to each transaction; and the like.

The preferred embodiments of the invention may be implemented in a computer-readable medium storing computer-readable instructions. The instructions are preferably executed by computer-executable components preferably integrated with an inertial tracking device. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

### 3. System for Managing Distributed Identity

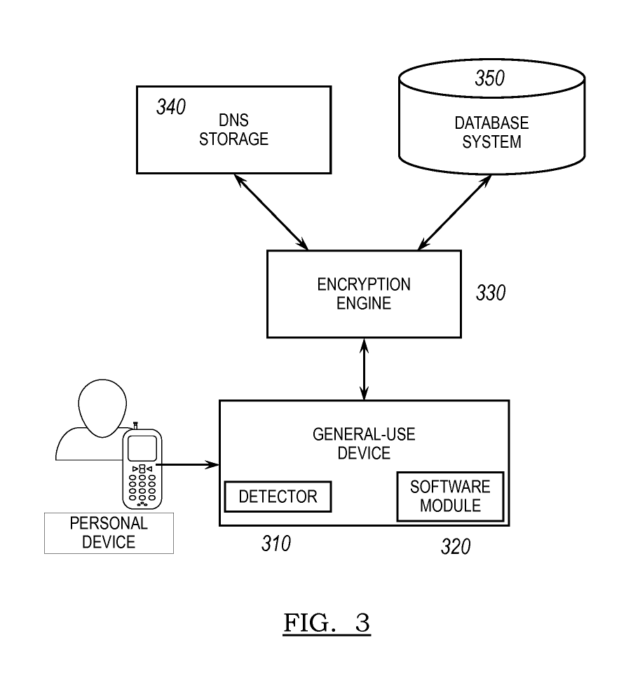

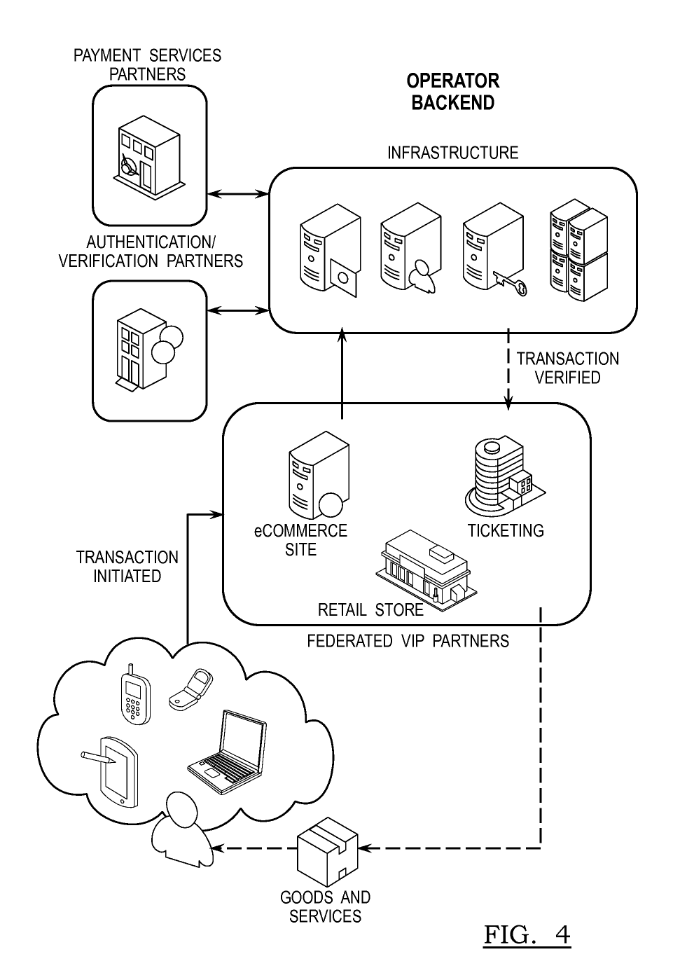

As shown in FIG. 3, a system 300 of the preferred embodiments for managing distributed identity includes a detector 310 capable of receiving a unique physical identifier of a user; a software module 320 capable of (1) retrieving identification data of the user comprising a username, a password, and metadata, and (2) combining the unique physical identifier and the identification data to create a unique identity record of the user; an encryption engine 330 capable of (1) encrypting at least a component of the unique identity record, and (2) creating a hash of an identifying token of the unique identity record; and domain name system (DNS) storage 340 capable of parsing the hash of the authentication token into a hierarchy, enabling organization of the unique identity record into a distributed database of a plurality of unique identity records. The components of the system 300 are preferably all on the same general-use device. The general-use device may be an ATM machine, a barcode scanner, a laptop computer, a tablet PC, a stationary PC, an RFID scanner, a mobile phone, or any suitable device capable of receiving the unique physical identifier of the user and transmitting data about that user to a remote server and/or database. Alternatively, as shown in FIG. 3, the components of the system 300 may not all be on the same general-use device.

The detector 310 capable of receiving a unique physical identifier of a user functions to authenticate the user. The unique physical identifier serves as an authentication token. A password may additionally or alternatively be used with the authentication token. The authentication token is preferably related to a personal device associated with a single user. The authentication token can preferably be identified through the presence of the device, as is described below. The necessary presence of a physical object for the authentication token preferably adds an additional layer of protection to the identification and authentication of the user. The user token and the authentication token are preferably associated with each other. As mentioned above, the authentication token is preferably related to a personal device associated with a single user. A mobile phone is one exemplary personal device due to the single-user nature of the mobile phone. In one embodiment, the unique physical identifier is a mobile device address. The personal device may alternatively be associated with an account, a family, a company, or any suitable entity that may benefit from identification. The personal device is preferably a mobile phone but may alternatively be a personal computer, a tablet computer, personal data assistant (PDA), handheld gaming device, an electronic book reader, and/or any suitable personal computing device. As another alternative, the personal device may be a non-computing device such as a key with an embedded RFID (Radio Frequency Identification) tag or a magnetic strip card. The personal device is preferably required to be on, with, or near the user during the identification/authentication process. The personal device preferably communicates with the general-use device through near-field communication, which is preferably accomplished according to Step S120 as described above.

In alternative embodiment, the unique physical identifier of the user is a biometric datum. Preferably, the biometric datum is a fingerprint. Alternatively, the biometric datum may be a palm print, iris scan, genetic identification of a skin or hair cell, or any other suitable imprint of a biological component of the user. The general-use device that receives the unique physical identifier of the user may be an ATM machine, a barcode scanner, a laptop computer, a tablet PC, a stationary PC, an RFID scanner, a mobile phone, or any suitable device capable of receiving the unique physical identifier of the user and transmitting data about that user to a remote server and/or database.

The software module 320 capable of (1) retrieving identification data of the user comprising a username, a password, and metadata, and (2) combining the unique physical identifier and the identification data to create a unique identity record of the user functions to aggregate the user data into one unit. In the preferred embodiment, this software module is a component of the general-use device.

The retrieval of identification data is preferably completed at the time the user signs-up or creates an account either through a service of the system operator, a partner using an application programming interface (API) to interact with the infrastructure of the system operator, or through any suitable means. The identification data may alternatively be collected at any suitable time. The identification data is manually entered into fields on the website. Alternatively, the identification data may be automatically retrieved from data that is already stored on a user's computer or mobile device. Alternatively, the identification data may be retrieved through a mobile phone application, software package, or any other suitable means of data entry. In an alternative embodiment, the identification data is sent via snail mail to the system operator and entered into a system by the system operator.

In addition to the username, the password, and the metadata, the identification data may further include an email address, a cell phone number, an IP address, an electronic serial number, a birthday, a mail address, a social security number, a driver's license number, a photograph, a video, an identifying piece of clipart, an answer to a secret question, a financial instrument (e.g., a credit card), an account number, a biometric datum, or any other suitable piece of identifying data.

The encryption engine 330 capable of (1) encrypting at least a component of the unique identity record, and (2) creating a hash of an identifying token of the unique identity record functions to secure the data in the unique identity record, which is preferably accomplished according to Steps S140 and S150, respectively, as described above.

The domain name system (DNS) storage 340 capable of parsing the hash of the authentication token into a hierarchy, functions to store authentication information. The parsing of the identifying token is preferably accomplished by the Domain Name System (DNS), which can enable data failover and can decrease lookup time during the authentication process. The unique identity record of the user is preferably passed along with the hash of the identifying token of the unique identity record to DNS. The encrypted data in the record is preferably formatted in a standard XML format but may alternatively be formatted as JSON or any suitable data representation. The encrypted data is preferably compressed and base-64 encoded, but any suitable encryption may be used. The formatting of the encrypted data preferably occurs on the platform of the present invention. Alternatively, the formatting may occur on a remote server. In one example, the format of the data is preferably: {(hash of the identifying token of the unique identity record)}:{(encoded XML data)}. Storing the data in this format enables it to be easily queried and addressed in DNS. For example, if the system loses access to a database containing a unique identity record, the hash of the identifying token of the unique identity record may be parsed to enable a quick lookup of a duplicate copy of the unique identity record on DNS.

The general-use device preferably contains a port or other component enabling communication with the distributed database. The distributed database is preferably a secure relational database. The records stored in the distributed database are preferably duplicated on the DNS. Thus, if a component of the distributed database fails, the user identity record can be queried on the DNS. The distributed database is preferably accessible to the system operator. Alternatively, a federated partner or group of federated partners may have private keys necessary to decrypt the unique identity records on the distributed database.

As a person skilled in the art will recognize from the previous detailed description and from the figures and claims, modifications and changes can be made to the preferred embodiments of the invention without departing from the scope of this invention defined in the following claims.

We claim:

1. A method for managing a distributed identity, comprising:
retrieving identification data of a user, wherein the identification data includes a username, a password, and metadata;
receiving, from a general-use device, a unique physical identifier of the user;
combining the unique physical identifier and the identification data to create a unique identity record of the user;
encrypting at least a component of the unique identity record;
creating a hash of an identifying token of the unique identity record;
passing the hash of the identifying token of the unique identity record to be parsed into a hierarchy;
organizing the unique identity record in a distributed database of a plurality of unique identity records; and
storing the unique identity record, containing the encrypted component, in the distributed database of the plurality of unique identity records.

2. The method of claim 1, further comprising:
encrypting a component of the unique identity record with a public key;
generating a private key capable of decrypting the component of the unique identity record available to a federated partner;
and sharing the private key with a federated partner, thus enabling a federated encryption process.

3. The method of claim 2, further comprising sharing the private key with a second federated partner.

4. The method of claim 1, further comprising:
retrieving identification data of a second user, wherein the identification data of the second user includes a username, a password, and metadata;
receiving, from a general-use device, a unique physical identifier of the second user;
combining the unique physical identifier and the identification data to create a unique identity record of the second user;
encrypting at least a component of the unique identity record of the second user;
creating a hash of an identifying token of the unique identity record of the second user;
passing the hash of the identity token of the unique identity record of the second user to be parsed into a hierarchy;
organizing the unique identity record of the second user in a distributed database of a plurality of unique identity records; and
storing the unique identity record of the second user, containing the encrypted component, in the distributed database of the plurality of unique identity records.

5. The method of claim 1, wherein the identification data is retrieved from a user's mobile device.

6. The method of claim 1, wherein the identification data further comprises an identifier selected from a group consisting of an email address, a cell phone number, an IP address, an electronic serial number, a mail address, a social security number, a driver's license number, an answer to a secret question, and a biometric datum.

7. The method of claim 1, wherein the general-use device is selected from a group consisting of a mobile phone, a tablet PC, a stationary PC, a laptop, an ATM machine, a bar code scanner, and an RFID scanner.

8. The method of claim 1, wherein the unique physical identifier of the user is a mobile device address, wherein the mobile device is any selected from a group consisting of a mobile phone, a tablet computer, a laptop, and a pager.

9. The method of claim 1, wherein the unique physical identifier of the user is a biometric datum.

10. The method of claim 9, wherein the biometric datum is a fingerprint.

11. The method of claim 1, wherein detection of the unique physical identifier of the user is enabled through near-field communication.

12. The method of claim 1, wherein the identifying token of the unique identity record is the unique physical identifier of the user.

13. The method of claim 1, wherein the encrypting of the component of the unique identity record includes the generation of a RSA public and private key pair.

14. The method of claim 13, wherein the private key is accessible to the user.

15. The method of claim 13, wherein the private key is accessible to a calling API partner.

16. The method of claim 1, wherein the identifying token of the unique identity record is hashed with SHA-256.

17. The method of claim 16, wherein the identifying token of the unique identity record is further encrypted with advanced encryption standard (AES).

18. The method of claim 1, wherein parsing the hash of the identifying token of the unique identity record into a hierarchy utilizes domain name system (DNS).

19. The method of claim 18, wherein DNS is used for data failover.

20. A method for authenticating a user's identity in a distributed identity management system, comprising:
receiving, from a general-use device, a unique physical identifier of a user;
creating a hash of the unique physical identifier of the user;
querying a distributed database of unique identity records, organized according to a hierarchy of names with the hash of the unique physical identifier of the user, for a unique identity record of the user;
determining, based on a query result, an authentication status; and
returning, if there is authentication, a component of the contents of the user's unique identity record.

21. A system for managing a distributed identity, comprising:
a detector capable of receiving a unique physical identifier of a user;
a software module capable of:
retrieving identification data of the user comprising a username, a password, and metadata; and
combining the unique physical identifier and the identification data to create a unique identity record of the user;
an encryption engine capable of:
encrypting at least a component of the unique identity record; and
creating a hash of an identifying token of the unique identity record that identifies the unique identity record; and
domain name system (DNS) storage capable of parsing the hash of the authentication token into a hierarchy, enabling organization of the unique identity record in a distributed database of a plurality of unique identity records.
